(19) United States
(12) Patent Application Publication
(10) Pub. No.: US 2014/0100746 A1
(43) Pub. Date: Apr. 10, 2014

(54) System and Process for Predicting Energetically Relevant Driving Situations Without a Road Map

(71) Applicant: Bayerische Motoren Werke Aktiengesellschaft, Muenchen (DE)

(72) Inventors: Andreas WILDE, Oberhaching (DE); Johannes von GRUNDHERR, Muenchen (DE); Margherita FILIPPINI, Muenchen (DE); Evgeny KOZLOV, Muenchen (DE); Milton MENDIETA, Muenchen (DE)

(73) Assignee: Bayerische Motoren Werke Aktiengesellschaft, Muenchen (DE)

(21) Appl. No.: 14/045,218

(22) Filed: Oct. 3, 2013

(30) Foreign Application Priority Data
Oct. 4, 2012 (DE) 102012218152.0

(51) Int. Cl. G01C 21/36

(52) U.S. Cl. CPC G01C 21/3697
USPC 701/51; 701/1; 701/67; 701/123

(57) ABSTRACT

A process and system is provided for anticipatory energy management in vehicles, including providing a driver with anticipatory driving style information. The system includes a sensor interface that acquires vehicle sensor data, a position interface that acquires position data of the vehicle, a storage module that stores an event databank, and an output unit that outputs information concerning an imminent driving event to the driver. A driving event is detected from the acquired position and sensor data, and is stored as an event dataset in the event databank, the driving event being associated with an event position. The system may also recognize from the acquired position data that the vehicle is driving on a current route that includes the event position, and may output information concerning the stored driving event from the output unit before the vehicle reaches the event position.

### CROSS REFERENCE TO RELATED APPLICATIONS

This application claims priority under 35 U.S.C. §119 from German Patent Application No. DE 10 2012 218 152.0, filed Oct. 4, 2012, the entire disclosure of which is expressly incorporated by reference herein.

### BACKGROUND AND SUMMARY OF THE INVENTION

The invention relates to processes and systems for anticipatory energy management in vehicles.

Currently, vehicles (particularly vehicles without a navigation device or without a digital map) do not have anticipatory information along a driving route lying ahead. In particular, vehicles do not have data that make it possible for a vehicle itself or for the driver of the vehicle to adapt the driving style with respect to energy efficiency. It is therefore also not possible to make recommendations to the driver with respect to an efficient anticipatory driving style.

The present document describes systems and processes respectively which make it possible (also without the availability of a navigation system) to make driving recommendations to a driver concerning an anticipatory efficient driving style and to thereby integrate an anticipatory energy management in vehicles. As a result, it becomes possible to reduce the fuel consumption of vehicles.

According to one aspect, a system for an anticipatory driving behavior assistance to a driver of a vehicle may, for example, be integrated in an information and communication system of the vehicle. The system may have a sensor interface which is set up for acquiring sensor data from a plurality of sensors of the vehicle. The sensor data may, for example, comprise one or more of the following: data of a braking sensor, data of a clutch sensor, data of a transmission sensor, data of an acceleration sensor, data of a speed sensor, and/or data of a steering sensor.

Furthermore, the system may comprise a position interface which is set up for acquiring position data of the vehicle. The position interface may particularly be set up to receive the position data of the vehicle from a vehicle-external GPS receiver (“vehicle-external” referring to a GPS receiver that is not a part of a vehicle navigation system, for example, from the GPS receiver of a personal electronic device, such as a smartphone). This allows the offering of anticipatory driving assistance also in vehicles which have no integrated navigation system.

The system can further comprise a storage module which is set up for storing an event databank. One or more event datasets can be stored in the event databank, an event dataset comprising information concerning a past (energy-relevant) driving event. This stored information can be made available to the driver when it is detected that the vehicle is moving on a current road that comprises an already stored driving event. A driving event may comprise one or more of the following: A turn-off event, a coasting event, a cornering event, a destination event, a stopping event, and/or a braking event.

The system can further comprise an output unit which is set up for outputting information concerning an imminent driving event to the driver. The output unit may, for example, comprise a video screen (for example, the video screen of the vehicle-internal information and communication system) so that the information can be outputted as image information. As an alternative or in addition, audio information (for example, warning instructions or spoken instructions) can also be outputted.

The system can be set up for detecting a driving event by the acquired position data and by the acquired sensor data and storing it as an event dataset in the event databank. The driving event is typically associated with an event position which indicates in which position or in which area the driving event was detected.

The system can further be set up to detect, by the acquired position data that the vehicle is driving on a current route on which the event position is also situated. For this purpose, for example, route information can be stored in the system. As an alternative, a navigation system could also detect that the planned route comprises the event position.

The system can be set up for outputting information concerning the stored driving event by way of the output unit before the event position has been reached. The driver can thereby be enabled to initiate measures for managing the imminent driving event as energy-efficiently as possible. The information concerning the stored driving event may particularly comprise recommendations to the driver concerning an energy-efficient driving style. By the storage of driving events which are relevant to the fuel consumption of the vehicle, and by the anticipatory information concerning stored driving events, the driver can be encouraged to gradually reduce the fuel consumption in an iterative process (i.e. when repeatedly driving through the same driving event).

The storage module can be further set up to store a position databank, and the system can be set up to generate a plurality of position data by the acquired position data and store them in the position databank. In this case, each one of the plurality of datasets is associated with a pertaining position. By acquiring position datasets, the system can acquire historical driving information of the vehicle. In particular, the system can store information concerning the positions (and therefore the routes) on which the vehicle has been driving so far. As a result, it becomes possible to recognize a currently driven route even if the vehicle has no digital maps (and/or no navigation system).

Furthermore, the storage module can be set up for storing a route databank, and the system can be set up for storing a route dataset which describes a stored route on which, in a certain sequence, the positions of at least some of the plurality of position datasets and the event position are situated. In other words, a route dataset describes a certain stored (historical) route by a sequence of positions (which also comprises the event position). The system can therefore be set up for recognizing by the certain sequence of at least two positions, that the current route corresponds to the stored route. This means that the system can be set up for recognizing an already previously driven route even if the system comprises no digital map and/or no navigation device.

The system can be set up for acquiring a fuel consumption between positions associated with the plurality of position datasets by the sensor data and storing these positions in consumption datasets. A consumption data set can, for example, reflect the historical fuel consumption between the positions of two position datasets. The system can thereby be enabled to determine a reference fuel consumption for the stored route from the consumption datasets. The system can then be set up for outputting information concerning the reference fuel consumption by way of the output unit. This information can still be outputted before the reaching of the destination of the current route and, as required, be compared with an actual consumption. The driver can thereby be encouraged to adapt his driving style in order to reach the reference fuel consumption or to fall below it.

The system can be set up for detecting, by the acquired position data, that a current position is already stored as a position dataset. It can thereby be avoided that double datasets are established. The existing position dataset can instead be updated. A frequency value of the position data set can, for example, be increased which indicates how frequently a drive to the position of the position dataset has taken place.

The system can also be set up for recognizing that a current position of the vehicle is not situated on the stored route and is also not yet stored as a position dataset. In this case, a new position data set with the current position of the vehicle can be stored in the position databank.

According to a further aspect, a process is described for assisting an anticipatory driving style of a driver of a vehicle. The process may comprise the following: An acquisition of sensor data of a plurality of sensors of the vehicle, an acquisition of position data of the vehicle, a detecting of a driving event by the acquired position data and sensor data, a storing of the driving event with a pertaining event position as an event dataset, a recognition by the acquired position data that the vehicle is driving on a current route on which the event position is also situated, and an outputting, before reaching the event position, of information concerning the stored driving event.

A software (SW) program is described according to a further aspect. The SW program can be set up in order to be implemented on a processor and in order to thereby implement the process described in this document.

A storage medium is described according to a further aspect. The storage medium may comprise an SW program which is set up to be implemented on a processor and to thereby implement the process described in this document.

It should be noted that the processes, devices and systems described in this document can be used alone as well as in combination with other processes, devices and systems described in this document. Furthermore, all aspects of the processes, device and systems described in this document can be combined with one another in multiple fashions. In particular, the characteristics of the claims can be mutually combined in multiple fashions.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is FIG. 1 is a view of a block diagram of an embodiment of a system in accordance with the present invention;

FIGS. 2a and 2b are views of embodiments of data structures for the acquisition of relevant driving situations in accordance with the present invention; and

FIG. 3 is a view of a function diagram with an embodiment of a function for permitting an anticipatory driving style in accordance with the present invention.

### DETAILED DESCRIPTION OF THE DRAWINGS

As noted above, the present invention is directed to determining an anticipatory driving style in a vehicle, and thereby allowing an anticipatory energy management in vehicles. In this context, systems and corresponding processes are described which make it possible to acquire in a structured manner energy-relevant data concerning already driven routes or route sections and to make these data available to the driver of the vehicle for an anticipatory energy management.

The described systems/processes can particularly also be used in vehicles which have no navigation system (particularly no digital map information), and therefore also permit no data-based route planning. This is particularly so in mid-size and small-size vehicles of which only a few have integrated navigation systems. In contrast, so-called Smartphones with a GPS sensor and sufficient storage and computing resources are increasing worldwide. The GPS sensors available in such personal electronic devices may be utilized for the purpose of an anticipatory energy management. For example, using the sensor system available in the vehicle as well as a GPS sensor available outside the vehicle (or inside the vehicle) permits—as a function of the position—storing energetically relevant driving situations and, when the same (partial) route is traveled again, making them retrievable again. This permits a comfortable, anticipatory and relaxed driving because the driver can be informed in time of the already stored energetically relevant driving situations. In addition, a lower fuel consumption and lower emissions can be achieved in this manner.

FIG. 1 illustrates a block diagram of an example of the system 100 for allowing an anticipatory driving style. The system 100 comprises a coordination unit 110 which is set up for acquiring data from different vehicle-internal and/or vehicle-external sources and storing them in a structured manner. The coordination unit 110 is further set up for providing the acquired data as a function of the situation in order to thereby permit an anticipatory—and energy-efficient—driving style. The coordination unit 110 may, for example, be integrated in an information and communication system (IK system) of a vehicle.

The coordination unit 110 comprises, for example, a sensor interface 112 which is set up for receiving data from a plurality of vehicle sensors 130. Examples of vehicle sensors 130 are a brake sensor which is set up for acquiring the braking of the vehicle; a clutch sensor which is set up for acquiring a clutch status (for example, released or fixed clutch between the engine and the transmission); a transmission sensor which is set up for acquiring a current transmission gear; an acceleration sensor which is set up for acquiring the actuation of the accelerator pedal for the acceleration of the vehicle; a speed sensor which is set up to acquire an actual speed of the vehicle; a steering sensor which is set up for acquiring a steering angle of the steering wheel of the vehicle, etc.

The data received from the vehicle sensors 130 can be used for the definition and/or storage of so-called “events”. Examples of driving events are, for example,

a turn-off event: This event exists, for example, when, within a predefined turn-off time interval, the acquired speed of the vehicle is below a turn-off threshold value (for example 10 km/h) and the steering angle is above a turn-off threshold value (for example, 60°).

a coasting event: This event exists, for example, when the clutch is released for a time period that comprises at least one pre-defined coasting interval.

a cornering event: This event exists, for example, when the steering angle is within a cornering interval (for example 20° to 60°). As a further condition, it could also be defined that a minimal cornering speed (for example 20 km/h) is exceeded isochronously.

a destination event: This event exists, for example, when a manual switching-off of the engine and/or a removal of the vehicle key is detected.

a stopping event: This event exists, for example, when, for a time period which comprises at least one predefined stopping time interval, the speed of the vehicle is at or below a predefined stopping speed (for example, 1 km/h). By an appropriate combination of conditions, a differentiation can, for example, be made between a planned stopping point (red traffic light) or a traffic jam.

The above-indicated list of events is an example of a plurality of events which may be significant for an anticipatory energy-efficient driving style. The coordination unit 110 can be set up for defining, detecting during the drive of the vehicle and recording a plurality of driving events by the combination of one or more conditions with respect to the detected sensor data of the vehicle sensors 130. For example, the control unit 110 may comprise a storage module 113 in order to store detected driving events.

The coordination unit 110 can further comprise a position interface 114. The position interface 114 can, for example, receive position data concerning the actual position of the vehicle from an external personal electronic device 120) (for example, a smartphone) which comprises a positioning receiver 121 (such as a GPS receiver). However, the position interface 114 may also receive the position data from a vehicle-internal positioning receiver. For the communication with the coordination unit 110, an external personal electronic device 120 may comprise a suitable communication interface 124 (for example, Bluetooth) as well as a suitable communication software (such as an “app”).

The coordination unit 110 can acquire the position data received by way of the position interface 114 and store them in the storage module 113. In particular, the coordination unit 110 can determine and store, by the position data, the route or route sections driven by the vehicle. In addition, the coordination unit 110 can be set up to provide detected driving events with the corresponding position data which indicate in which position the detect driving event has occurred.

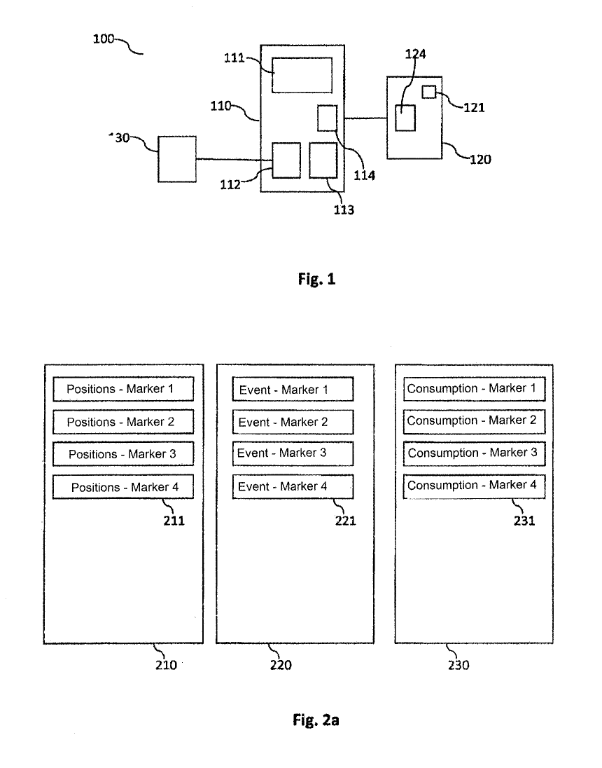

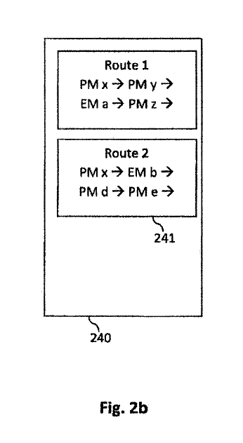

FIGS. 2a and 2b show examples of data structures which can be determined by the coordination unit 110 by position data and by sensor data and can be stored in the storage module 113. The coordination unit 110 can, for example, be set up for establishing and for maintaining a position databank 210. The position databank 210 may comprise a plurality of position markers 211 (also called position datasets 211). A position dataset 211 comprises, for example, the position data (for example, the GPS coordinates) of a position on a route which the vehicle has already traveled. The coordination unit 110 may, for example, be set up to acquire and store a position dataset during the drive of the vehicle at regular distances (for example, at distances of 50, 100 or 200 m). The position databank 210 therefore comprises information (with a defined grid accuracy) concerning the positions to which the vehicle has driven so far.

As a result of the vehicle driver's habits (drive to work, drive to a leisure activity, drive to a vacation destination), certain routes are repeatedly traveled by means of the vehicle. Typically, repetition rates occur of up to 80%, so that the drive repeatedly takes place to the same positions. The coordination unit 110 can be set up to recognize that a drive has already taken place to a certain position and that a position dataset 211 had already been stored for this position. It is thereby achieved that, when the same routes are driven repeatedly, no repeated position datasets 211 are stored, so that the effectively required storage space for the position databank 210 (because of the repetitive routes) can be limited. A position dataset 211 may comprise a frequency counter which acquires how frequently a drive has taken place to the corresponding position. The coordination unit 110 can be set up to augment the frequency counter in the case of a repeated driving to the corresponding position. Thus, particularly frequently traveled positions (and routes) can be determined and especially be taken into account when permitting an anticipatory driving style.

The coordination unit 110 can further be set up for establishing and maintaining an event databank 220. The event databank 220 comprises a plurality of event markers 221 (also called event datasets 221). An event dataset 221 is established for a detected driving event. It comprises an indicator for the type of the driving event (for example, a code which indicates the type of the driving event: sailing event, cornering event, etc.). In addition, the event dataset 221 comprises the position data (for example, the GPS coordinates) of the detected driving event. Furthermore, the event dataset 221 may comprise a frequency counter which indicates how frequently (for example, how many times) the detected driving event has already occurred in the corresponding position. The relevancy of the detected driving event can thereby be acquired.

The coordination unit 110 may further be set up for establishing and maintaining a consumption databank 230. The consumption databank 230 comprises a plurality of consumption markers 231 (also called consumption datasets 231). A consumption dataset 231 comprises information concerning the fuel consumption on certain partial routes. For example, a consumption dataset 231 may be associated with two position datasets 211 respectively, and may indicate the fuel consumption between the positions of the two position datasets 211. In an example, a consumption dataset 231 comprises an indicator for a starting position (for example, an indicator on a first position dataset 211) and an indicator for an end position (for example, an indicator on a second position dataset 211) and thereby defines a partial route. For a partial route, the consumption dataset 231 can indicate a maximal fuel consumption acquired so far, a minimal fuel consumption acquired so far, and/or an average fuel consumption. The coordination unit 110 can be set up for updating this information in the case of a repeated driving on the partial route.

The coordination unit 110 can further be set up for establishing and updating a route databank 240. The route databank 240 comprises a plurality of route datasets 241 which indicate the routes which have already been driven by the vehicle. A route dataset represents a linking-together (for example, a sequence) of position datasets 211 and/or event datasets 221, whose positions (for example, GPS coordinates) are situated on the corresponding route. As mentioned above, as a result of the driver's habits, the vehicles repeatedly drive along the same routes, so that the effective number of different route datasets 241 in the route databank 240 is relative small in practice. A route dataset 214 may comprise a frequency counter which indicates how often the corresponding route has already been traveled. The frequency counter can, for example, be used for deleting infrequently driven routes and thereby reduce the required storage space.

By the datasets illustrated in FIGS. 2a and 2b, the coordination unit 110 acquires a picture concerning the vehicle driver's previous driving behavior and driving habits. The collected information can be used for making recommendations to the driver concerning imminent driving situations (for example, by way of an output module 111 of the coordination unit 110), and thereby optimize the driver's driving style (for example, with respect to fuel consumption).

In other words, it is an object of the system 100 to collect data 210, 220, 230, 240 of frequently driven routes by the sensor system 130 of a vehicle, in order to:

recognize these routes when again driving on the route.

offer a comparison of the data of the different drives along the route to the driver (for example, consumption or driving time in comparison to the so far most economical/fastest drive). These date can be obtained, for example from the route dataset 241 of the retraveled route. The data can be displayed on the output module 111 (for example, a video screen of the IK system). The comparison can take place on partial routes or the total route. The consumption datasets 231 can be used for determining the consumption data (on partial routes or total routes). The driven route can be recognized in time by the coordination unit 110 (as a result of a series of currently detected positions), so that the reference consumption value can be displayed already at the start of the drive and not only afterwards and can therefore be motivating. For example, the following information could by outputted: “During the last drive on this route, you achieved an average consumption of 4.3 liters—you are currently still at 4.5”.

draw the driver's attention in an anticipatory manner to situations in which he can save fuel (on the basis of the acquired event datasets 221). For this purpose, energetically relevant situations of the drives are stored in the event datasets 221, for example, strong braking before entering towns or cities, cornering, rotary traffic or turn-off operations, and are indicated to the driver in time during the next drive. The following information could, for example, be outputted: “curve after 200 m, release the gas pedal.”

As explained above, the system 100 has one or more of the following characteristics and functions:

When a new route is traveled, position markers 211 are set according to a defined triggering condition and are stored in the position databank 210. The triggering condition may, for example, be the condition that the last marker 211 has already been passed by a certain distance (for example, 50 m, 100 m or 200 m). A further condition may, for example, be that the position marker 211 does not yet exist in the databank 210.

The position markers 211 may have a route and/or marker number; for example, (5/14)=route 5, marker 14, and can be given in an ascending manner, for example, (5/1), (5/2), (5/3), etc. In the example of FIGS. 2a/2b, the position markers 211 comprise a marker number for the identification. In addition, in the case of a newly traveled route, a route dataset 241 is generated which refers to the position markers 211 corresponding to the route (in the sequence corresponding to the route).

The position markers 211 can contain all necessary information for recognizing a position or a route (GPS position, preceding and following position marker 211, driving frequency). In the example illustrated in FIGS. 2a/2b, the position markers 211 contain information concerning the GPS position and, if required, concerning the driving frequency. The information concerning a defined driven route is stored in a route dataset 241 (for example, sequence of position markers 211).

In the case of special driving events, event markers 221 can additionally be set and stored (examples of special driving events are a cornering, turn-off, strong braking, destination reached, etc.). In the example illustrated in FIGS. 2a/2b, in the case of a detection of a driving event, an event dataset 221 is generated and stored, to which reference is made in the route dataset 241 pertaining to the route. When, for example, the driving event EM a is between position markers PM y and PM z, the route dataset 241 may comprise a reference to the event dataset 221 EM a between the references to the position markers PM y and PM z (see FIG. 2b).

When the vehicle reaches an already set position marker 211 or event marker 221 (taking into account a tolerance depending on the accuracy of the position data, of, for example, 30 m), no further markers will be set for a defined driving route. If necessary, the information in the already set markers 211, 221 can be updated.

When the vehicle reaches two successive already set position markers (for example, (5/3) and (5/4)), it may be assumed that the corresponding route (in the example, route “5”) is traveled in the corresponding direction (in the example, “forward”). The condition “route recognized” is taken up. In other words, the coordination unit 110 can be set up to recognize that the vehicle is approaching already set position markers 211. In particular, the coordination unit 110 can recognize that a sequence of position markers 221 (for example, a sequence of at least two markers 221) is approached in a certain sequence. The sequence of position markers 221 can be compared with the route datasets 241 (for example, by means of an inverse search index). When a route dataset 241 is determined which comprises the same sequence of position markers 221, it can be assumed that the vehicle is situated on the route corresponding to the route dataset 241. In addition, it can be recognized in which direction (forward or backward) the route is traveled that corresponds to the route dataset 241. As a further indication for the substantiation of this hypothesis, the coordination unit 110 can use the frequency value of the determined route dataset 241 (a high frequency value points to a high probability that the same route is being traveled). The stored position markers 211 and/or the stored route datasets 241 therefore make it possible to recognize, even without the presence of a navigation system in the vehicle, that the vehicle is again driving on an already traveled route.

Typically, in the “route recognized” position, no new position markers are therefore set (but possibly updated).

The system 100 assumes (up to the recognition of a deviation from the recognized route of the recognized route dataset 241) that the driver is traveling on the stored route. The data and events stored for the recognized route can be used for the above-described functions. In particular, the driver can be informed in time of a driving event situated on the route. If, for example, the route 1 was recognized in FIG. 2b and if the vehicle is currently at or in front of the position marker PM x, the coordination unit 110 can inform the driver in time concerning the driving event EM a.

The “route recognized” state can be left when the expected next position marker 211 is not encountered in the appropriate route or when a marker 211 of another route 1 is encountered. For reducing the storage demand, position markers 211, event markers 221 and/or consumption markers 231 of routes that are no longer traveled can be deleted after a certain time. For this purpose, the respective markers can be provided with a time stamp which indicates when the respective marker was encountered or updated the last time.

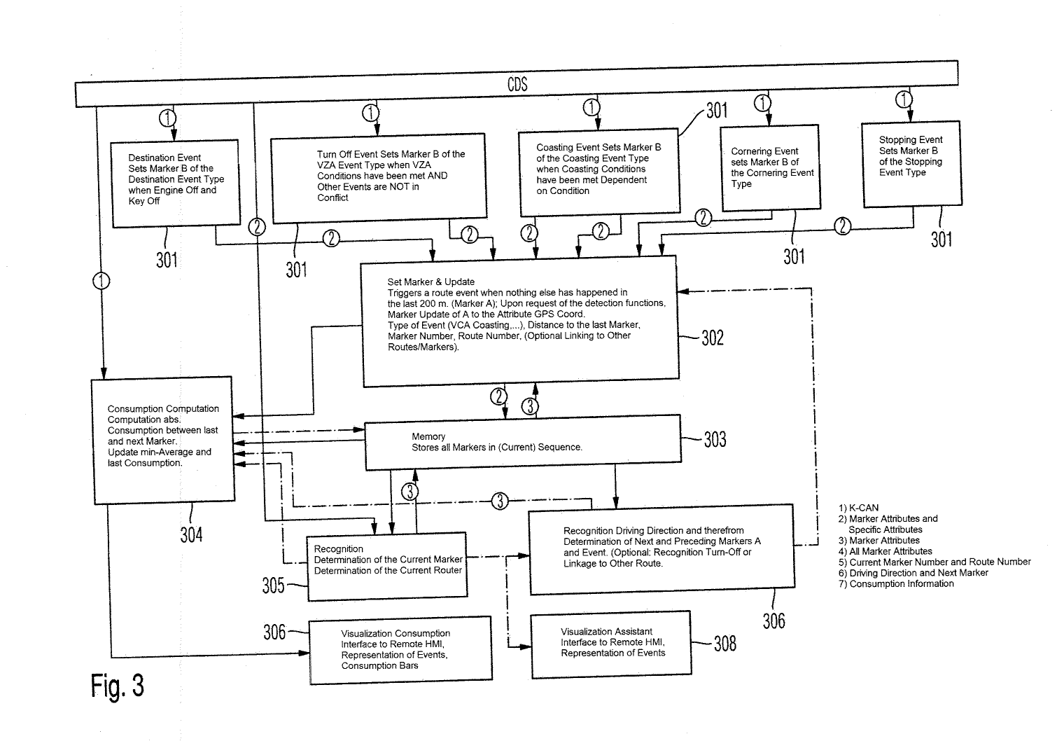

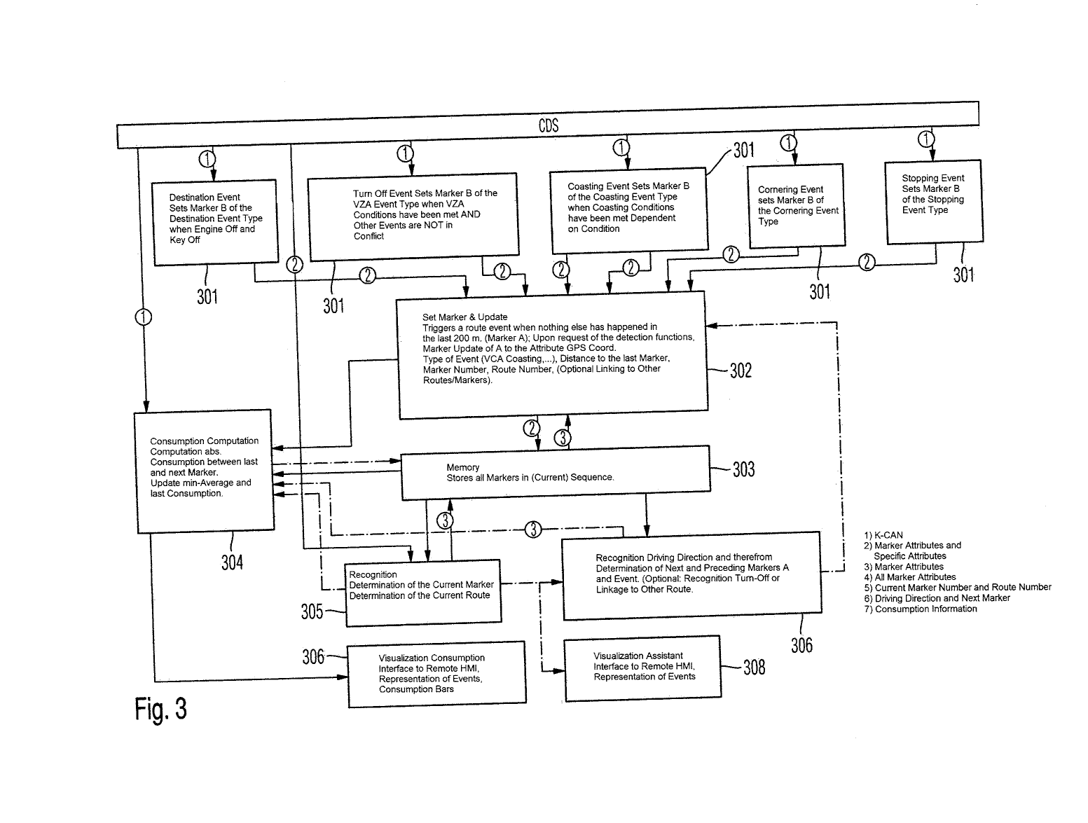

FIG. 3 is a view of an example of a diagram of functions for permitting or assisting an anticipator driving style. The functions are implemented, for example, within the scope of the coordination unit 110. The diagram of functions comprises a plurality of event-detection functions 301 which are set up to set and update event markers 221. For this purpose, the event-detection functions 301 use sensor data of the vehicle (which are transmitted, for example by way of a CAN bus of the vehicle). In other words, the event-detection functions 301 recognize energetically relevant events, such as the reaching of a destination, a turn-off, a conceivable coasting point, a cornering, a braking before entering a town or city, a rotary traffic, etc.

When an event-detection function 301 recognizes an event, it reports it to the “set marker and update” function 302. The function 302 triggers a position marker 211 when nothing else has happened at a predefined distance from the last position marker 211. In addition, the function 302 coordinates information of the event-detection functions 301. If a position marker 211 or an event marker 221 has already been recognized, the latter can be enriched by the new information. The information is transferred to the storage function 303. The storage function 303 stores and manages all collected information in the databanks 210, 220, 230, 240 on the storage module 113.

The consumption function 304 computes the consumption between the last and the subsequent position marker 211 and stores this information in a corresponding consumption dataset 231. In addition, the function 304, for example, updates the minimal and average consumption stored in the dataset 231.

The recognition and tracking functions 305, 306 recognize when the vehicle is in the proximity of a position marker 211. In addition, a conceivable known route and the driving direction can be recognized. By this information, the functions 305, 306 determine the next and/or the preceding position marker 211 and imminent driving events on the route. In addition, these functions 305, 306 recognize turn-offs or linkage to other routes.

The visualization function 307 indicates to the driver of the vehicle (for example, on the output unit 111) imminent driving events and/or consumption data. Furthermore, recommendations can be made as to how the imminent driving events can be managed in an energy-efficient manner.

In this document, systems and processes are described which assist an anticipatory energy-efficient driving style. The described system/processes can also be used in vehicles which have no navigation system. As a result of the recognition of a currently driven route, the driver can be informed of imminent driving events. Recommendations can be made to the driver as to how the imminent driving events can be mastered in an energy-efficient manner. It thereby becomes possible to reduce the fuel consumption of vehicles.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for determining an anticipatory driving style of a vehicle driver, comprising:
a sensor interface configured to acquire sensor data from at least one sensor of the vehicle;
a position interface configured to acquire position data of the vehicle;
a storage module configured to store an event databank; and
an output unit configured to output information concerning an imminent driving event to the driver,
wherein the system is configured to
detect a driving event from the acquired position data and acquired sensor data, the driving event being associated with an event position,
store the detected driving event as an event dataset in the event databank of the storage module,
recognize from the acquired position data when the vehicle is driving on a current route that includes the event position, and
output information concerning the stored detected driving event before the vehicle reaches the event position.

2. The system according to claim 1, wherein the driving event includes at least one of a turn-off event, a sailing event, a cornering event, a destination event, a stopping event and a braking event.

3. The system according to claim 1, wherein the acquired sensor data includes at least one of data of a braking sensor, data of a clutch sensor, data of a transmission sensor, data of an acceleration sensor, data of a speed sensor and data of a steering sensor.

4. The system according to claim 1, wherein
the storage module is configured to store the acquired position data in a position databank,
the system is configured to generate at least one position dataset from the acquired position data and store the at least one position dataset in the position databank, and
at least one of the at least one position dataset has an associated pertaining position.

5. The system according to claim 4, wherein
the storage module is configured to store a route databank,
the system is configured to store a route dataset associated with a stored route, the route dataset including in a defined sequence positions of at least one of the at least one position dataset and the associated pertaining position, and
the system is configured to recognize from the defined sequence positions at least two positions of the current route corresponding to the stored route.

6. The system according to claim 5, wherein
the storage module is configured to store a consumption databank, and
the system is configured to
determine from the sensor data a fuel consumption between positions stored associated with the at least one position dataset,
store the fuel consumption in the consumption databank,
determine from the at least one consumption dataset a reference fuel consumption for the stored route, and
output from the output unit information concerning the reference fuel consumption.

7. The system according to claim 4, wherein the system is configured to
recognize from the acquired position data that a current position of the vehicle is already stored in the position databank, and
augmenting a frequency value of the position dataset associated with the current position.

8. The system according to claim 5, wherein the system is configured to
recognize that a current position of the vehicle associated with the current route is not stored in the position databank, and
store a new position dataset associated with the current position of the vehicle in the position databank.

9. The system according to claim 1, wherein the position interface is configured to receive the position data of the vehicle from a vehicle-external GPS receiver.

10. A method for determining an anticipatory driving style of a vehicle driver, comprising the acts of:
acquiring sensor data from a plurality of sensors of the vehicle;
acquiring position data of the vehicle;
detecting a driving event from the acquired position data and sensor data, the driving event being associated with a pertaining event position;
storing the driving event with the pertaining event position as an event dataset;
recognizing from the acquired position data that the vehicle is driving on a current route that includes the pertaining event position, and
outputting information concerning the stored driving event before the vehicle reaches the pertaining event position.
